(19) United States
(12) Patent Application Publication
(10) Pub. No.: US 2005/0132366 A1
(43) Pub. Date: Jun. 16, 2005

(54) Creating virtual device for universal plug and play

(76) Inventor: John Charles Weast, Hillsboro, OR (US)

Correspondence Address: Julie L. Reed;MARGER JOHNSON & McCOLLOM, P.C., 1030 S.W. Morrison Street, Portland, OR, 97205, US

(21) Appl. No.: 10/738,728

(22) Filed: Dec. 16, 2003

(51) Int. Cl. G06F 17/00

(52) U.S. Cl. 718/1

(57) ABSTRACT

A control point can create a virtual device from two or more physical devices in a universal plug and play network. The control point capable of creating virtual devices may include a communications port to allow the control point to communicate with a network and a processor configured to discover capabilities of at least two devices on the network, combine the capabilities of at least two devices to create a virtual device, and advertise capabilities for the virtual device to the network.

### BACKGROUND

Universal plug and play, or UPnP technology, is a distributed, open network architecture, defined by the protocols used that allows devices to join a network, convey their capabilities and learn about the presence and capabilities of other devices in the network. Typically, UPnP technology networks use Transmission Control Protocol/Internet Protocol (TCP/IP) and other Internet protocols to allow them to fit into existing networks. UPnP technology networks are typically independent of any operating system, programming language or physical medium, such as wired or wireless, remote or local access, etc. The standards and descriptions used in a UPnP technology network is governed by the Universal Plug and Play Forum (www.upnp.org), a group of companies and individuals across the industry that want to provide standardized specifications for UPnP technology networks, thereby increasing the applicability, capability and spread of UPnP technology-based networking.

One application of UPnP technology is in home networks, although it may be used in any network. The Digital Home Working Group is currently working on standards and specifications to provide seamless interaction among computer electronics, mobile devices, personal computers, etc. The collaborative efforts of this group are focused on delivering an interoperability framework for networked media devices, including audio, video, control and other types of devices in the home. Home networks pose a particular challenge for both UPnP technology and Digital Home, in that they have an almost infinite supply and variety of devices from which consumers may select and for which the consumers may demand communication capabilities.

### BRIEF DESCRIPTION OF THE DRAWINGS

Embodiments of the invention may be best understood by reading the disclosure with reference to the drawings, wherein:

FIG. 1 shows an embodiment of a universal plug and play network.

FIG. 2 shows a block diagram of an embodiment of a virtual control point in a universal plug and play network.

FIG. 3 shows a block diagram of an embodiment of a virtual device in a universal plug and play network.

FIG. 4 shows a flow chart of an embodiment of a method of establishing a virtual control point in a universal plug and play network.

FIG. 5 shows a flow chart of an embodiment of a method of operating a virtual control point in a universal plug and play network.

### DETAILED DESCRIPTION OF THE EMBODIMENTS

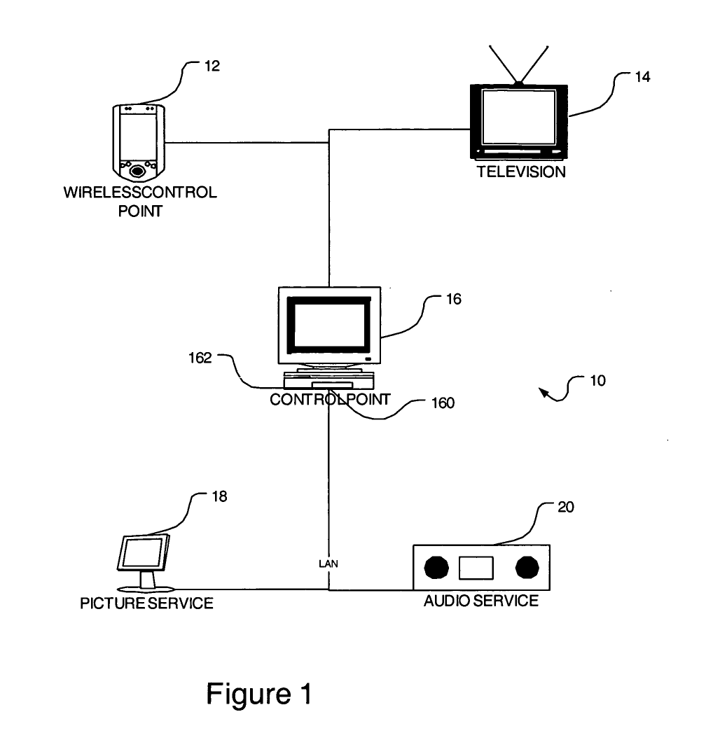

FIG. 1 shows an embodiment of a universal plug and play (UPnP) network 10. The flexibility of UPnP technology networks is that the connections between the devices in the network may be of several different types. For example, the wireless control point 12 may have several devices for which it provides control connected to it by wireless links, such as Institute of Electrical and Electronic Engineers (IEEE) standard 802.11b wireless links, infrared, or Bluetooth™ links. The television 14 may act as a control point for several video devices such as a satellite tuner, personal video recorder (PVR), VCR, DVD player, etc., linked to it via coaxial cable. Other types of devices are also possible members including telephones, printers, fax and other office machines, etc.

The control point has a communications port 160 that allows it to interact with the network, and a processor 162. In this particular example, a display 18 provides a picture service and an audio device 20 provides audio services, such a music play back. These devices happen to be linked to the control point 16 via a local area network (LAN), such as an Ethernet connection. The components shown in FIG. 1 involve at least one of the basic building blocks of a UPnP technology network: devices, services and control points.

The control point 16 is a device that has a controller or other processor with a higher level of capabilities. The control point will typically be a computing device that can retrieve device descriptions from devices and get lists of associated services, retrieve service descriptions for services in which the control point is interested, and subscribe to a server event source. This last allows the control point to be notified when a state of a service changes. Devices are the physical or logical entities, typically individual devices, in the UPnP technology network that provides the services. A device description will list a set of services provided by a device, as well as device properties, such as its name and icons or other information associated with the device.

Services are the smallest unit of control in a UPnP technology network. Services expose actions and model their states with state variables. For example, a clock service may have a state variable, current_time, which defines the state of the clock. It may also have two actions, set_time and get_time, which allow you to control the service. Devices may contain multiple services. The device description will typically contain a pointer to a service description, and both descriptions are typically in eXtended Markup Language (XLM).

The devices, services and control points may be configured in several ways. For example, a control point may also include the components necessary to allow the control point to function as a devices, such as a set-top box that not only acts as a tuner for the television, functioning as a device, but as a television control point to discover devices of a ‘television’ type and their associated services.

Currently, the descriptions of devices and services do not allow combination of services and functions to be utilized. For example, referring to the network of FIG. 1, a user wants to display pictures using the picture service provided by the display 18, synchronized with a musical selection played on the networked audio system 20. In the current state of UPnP technology networks, the user would have to manually set up the data streams to be synchronized and would have to produce and coordinate two separate data streams, one audio stream and one image stream, such as a video or a series of still images.

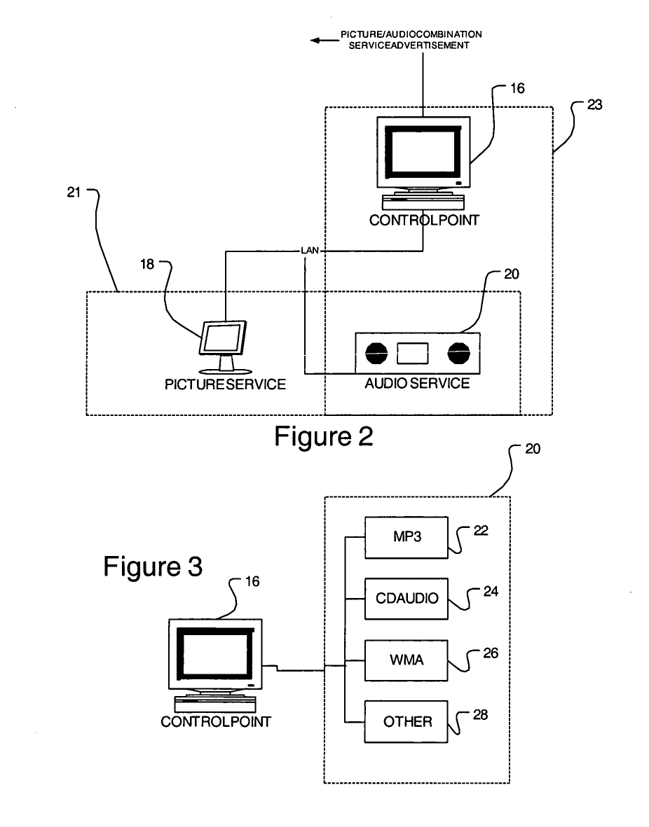

FIG. 2 shows an embodiment of the invention in which a control point 16 defines a virtual device comprised of the picture service from the display 18 and the audio playback service of the audio player 20. It must be noted that the virtual device 21 does not necessarily need to use all of the services provided by a particular device. For example, the splay 18 may have both a video playback and a still image display service. The virtual device may only need to use the still image display service, or it could combine all of them.

The control point 16 may reside along with the audio device, in device 23, or it may reside separately. Similarly, the control point may reside with the two devices that are being combined into a virtual device, such as a display driver, an audio card and the processor on a computer. Regardless of how the devices are configured, the control point forms a virtual device from the two devices 18 and 20. The control point takes the two device descriptions and service descriptions and combines them into a new device and/or service description. This new device description is then advertised to the network.

As far as the network can determine, the virtual device 21 is a network device like any other. Traffic for the new network device is sent to the control point 16, which would then act as a proxy for the two devices. The control point presents the device descriptions and service descriptions associated with the device as a device.

In another example, the audio device 20 may be made up of several individual audio devices. For example, virtual device 20 may be controlled by control point 16, to create an aggregated audio device that can handle several different types of audio, such as MP3 player 22 (Moving Pictures Experts Group, Level 3), CD AUDIO 24, WMA 26, or other 28. While the individual devices may not be able to play back all of the different types of audio, the new virtual device can do so. If the user wants to render audio on the WMA player, for example, but the audio stream may be in MP3 format. The control point could transcode the MP3 stream into WMA format and allow the data to be rendered on the WMA player device.

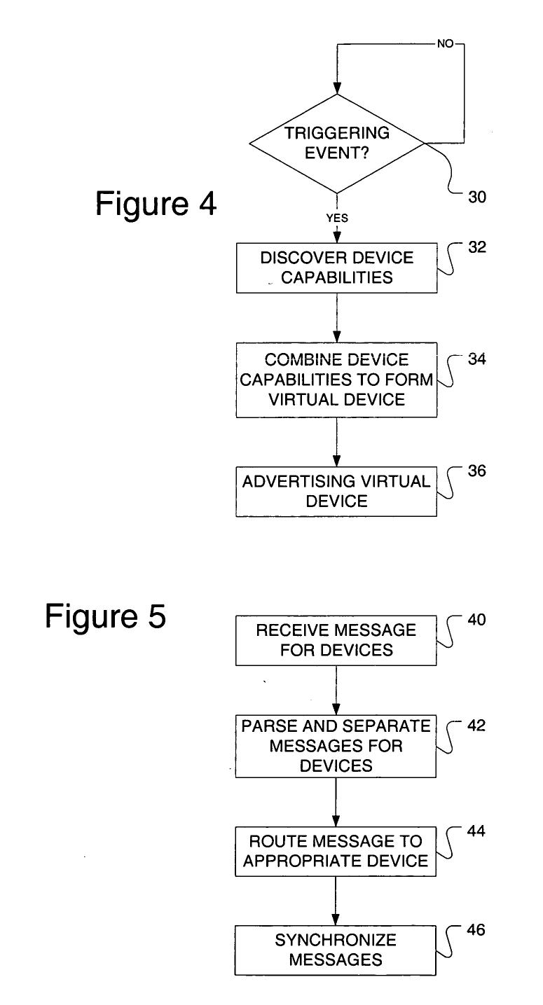

The establishment of the virtual device may be enabled by a virtual control point, which is a control point with the capability of forming virtual devices. The establishment of the virtual device generally arises at the occurrence of a triggering event at 30 in FIG. 4. A triggering event may be a direction from a system administrator to request formation of a new virtual device.

Alternatively, the triggering event may be a request from a user application. For example, a user application may request a combined display with audio playback. The control point may form the virtual device upon the request, and then advertise the services and the device description, as well as making the device available for the request.

In yet another alternative, a triggering event may be the announcement of a new device on the network. The control point may discover the device and its services then form virtual devices as the need arises or that may have been requested in the past. Once the triggering event occurs, the control point discovers the needed capabilities on devices in the network at 32. The control point then combined the capabilities for the devices that it has discovered on the network to form the virtual device at 34. Once the virtual device has been formed, the control point presents it as a new device at 36 by advertising its description and services on the network.

For example, the control point may receive a request for combined audio playback and picture display, as has been discussed above. The control point then discovers that the display 18 has the desired capability and the audio player 20 has the audio capability. The control point may then author a new XML script to advertise the new capability of the virtual device. The control point may record the individual network addresses, such as IP addresses, of the two separate devices used to create the virtual device. The address of the new device may be the address of the control point, or it may be a new address assigned to the virtual device, but associated with the control point on the physical network layer.

Once the virtual device has been formed, the control point acts as a proxy for the two new devices. An embodiment of this method is shown in flowchart form in FIG. 5. Assume an incoming message arrives at the control point addressed to the virtual device at 40. The control parses and separates the message into the portions addressed to each of the devices that make up the virtual device, if there are portions for each, at 42.

The control point then routes the appropriate message portion to the appropriate device at 44. If the message is a data stream, such as a combined audio and image data stream, the control point would parse the image stream out of the combined stream and route it to the display and would route the audio stream to the desired audio device as well. An optional process would be to synchronize the messages at 46, or the data streams, such that a particular piece of music is played with a particular series of images. This is optional, and is only included here as an example of the increased capabilities of the network made possible by the creation of the virtual device and its associated virtual control point.

In some instances, existing control points may be reconfigured to add the capability of virtual device creation. In these instances, the control point 16 would be upgraded with the software that provided this capability. This may involve the embodiments of the invention being contained as code on an article of machine-readable media that cause the machine to implement the methods of the invention when the code is executed.

Thus, although there has been described to this point a particular embodiment for a method and apparatus for creation of virtual devices in a UPnP technology network, it is not intended that such specific references be considered as limitations upon the scope of this invention except in-so-far as set forth in the following claims.

1. A control point, comprising:
a communications port to allow the control point to communicate with a network;
a processor configured to:
discover capabilities of at least two devices on the network;
combine the capabilities of at least two devices to create a virtual device; and
advertise capabilities for the virtual device to the network.

2. The device of claim 1, the device further comprising components to allow the control point to function as a device on the network.

3. The device of claim 2, the control point to function as a device selected from the group comprised of: a personal computer, a wireless device, a video display, an audio device, a printer, a telephone, an office a machine, and a television.

4. The device of claim 1, the processor to discover capabilities of at least two devices further comprise the processor to discover the capabilities of a device residing with the control point device.

5. The device of claim 1, the processor to combined the capabilities of at least two devices further comprising the processor to author a virtual device description containing device descriptions for the two devices.

6. The device of claim 1, the virtual device further comprising a device residing with the control point and another device.

7. The device of claim 1, the virtual device further comprising at least two devices residing separate from the control point device.

8. A method of establishing a virtual device, comprising:
receiving a triggering event at a control point n a network;
discovering device capabilities related to the triggering event;
combining device capabilities to create a virtual device; and
advertising capabilities of the virtual device.

9. The method of claim 8, receiving a triggering event further comprising receiving a direction from a system administrator.

10. The method of claim 8, receiving a triggering event further comprising receiving a request from a user application.

11. The method of claim 8, receiving a triggering event further comprising receiving an indicator of a new device on the network.

12. The method of claim 8, discovering device capabilities further comprising executing scripts provided from devices using extended markup language.

13. The method of claim 8, combining device capabilities further comprising authoring a virtual device description containing device descriptions obtained from devices discovered in response to the triggering event.

14. The method of claim 8, advertising the virtual device further comprising broadcasting a virtual device description on the network.

15. A method of operating a virtual device, comprising:
receiving incoming messages intended for the virtual device at a control point;
parsing the incoming messages to separate device messages intended for individual devices that are part of the virtual device; and
routing the device messages to the appropriate individual devices.

16. The method of claim 15, the method further comprising synchronizing the routing of the device messages to cause simultaneous processing of the device messages as necessary.

17. The method of claim 15, receiving incoming messages further comprising receiving an incoming data stream.

18. The method of claim 15, parsing the incoming message further comprising dividing an incoming data stream into device data streams.

19. The method of claim 15, parsing the incoming message further comprising identifying a message type to identify a physical device associated with that type.

20. A system comprising:
a device on a network having a discoverable capability;
a control point on the network to:
discover the capability of the device and capabilities of at least one other device;
combine the capability of the device and the capabilities of at least one other device into a virtual device; and
advertise capabilities of the virtual device on the network.

21. The system of claim 20, the control point further comprising a computing device and the device further comprising a component of the computing device selected from the group comprised of: an audio card, a display, a network music source, and a user application.

22. The system of claim 20, at least one other device being resident on the control point with the device.

23. The system of claim 20, at least one other device being resident separate from the control point.

24. An article of machine-readable media containing code that, when executed, causes the machine to:
receive a triggering event at a control point n a network;
discover device capabilities related to the triggering event;
combine device capabilities to create a virtual device; and
advertise capabilities of the virtual device.

25. The article of claim 24, the code causing the machine to receive a triggering event further causing the machine to receive a direction from a system administrator.

26. The article of claim 24, the code causing the machine to receive a triggering event further causing the machine to receive a request from a user application.

27. The article of claim 24, the code causing the machine to receive a triggering event further causing the machine to receive an indicator of a new device on the network.

28. The article of claim 24, the code causing the machine to discover device capabilities further causing the machine to execute scripts provided from devices using extended markup language.

29. The article of claim 24, the code causing the machine to combine device capabilities further causing the machine to author a virtual device description containing device descriptions obtained from devices discovered in response to the triggering event.

30. The article of claim 24, the code causing the machine to advertise the virtual device further causing the machine broadcast a virtual device description on the network.
